(19) United States
(12) Patent Application Publication
(10) Pub. No.: US 2025/0172473 A1
(43) Pub. Date: May 29, 2025

(54) SCANNING OCT OFF-WALL PARTICLE SIZING

(71) Applicant: INPROCESS IP B.V., AB OSS (NL)

(72) Inventors: Jeroen Kalkman, Oss (NL); Konstantine Cheishvili, Oss (NL)

(21) Appl. No.: 18/834,327

(22) PCT Filed: Jan. 30, 2023
(86) PCT No.: PCT/NL2023/050036

§ 371 Date: Jul. 30, 2024

(30) Foreign Application Priority Data
Jan. 31, 2022 (NL) 2030797

(51) Int. Cl. G01N 15/0205; G01F 1/712; G01N 15/0227; G01P 5/22

(52) U.S. Cl. CPC G01N 15/0211; G01F 1/712; G01N 15/0227; G01P 5/22; G01N 2015/0222

(57) ABSTRACT

A method for determining a characteristic of a flowing fluid having particles in a sample space by Fourier domain optical coherence tomography includes estimating a velocity of the fluid in the sample space; controlling an optical scanner to radiate a beam of light along an optical path to the fluid in the sample space and to sense a signal of interference of measurement light scattered back along the optical path mixed with reference reflected light, while moving the optical scanner, where the beam of light is moved with a scanner velocity being aligned with a velocity component of the velocity of the fluid perpendicular to the optical axis of the beam of light, processing the signal into a corresponding complex-valued optical path length resolved OCT signal, where the OCT signal represents the fluid in the sample space; determining the characteristic of the fluid based on the OCT signal.

### CROSS-REFERENCE TO RELATED APPLICATIONS

This application is the National Stage of International Application No. PCT/NL2023/050036, filed Jan. 30, 2023, which claims the benefit of Netherlands Application No. 2030797, filed Jan. 31, 2022, the contents of which is incorporated by reference herein.

### FIELD OF THE INVENTION

The invention relates to a method for determining a characteristic of a flowing fluid by optical coherence tomography.

### BACKGROUND OF THE INVENTION

Methods to analyze fluids containing nanoparticles are known in the art. EP 3 671 110, for instance, describes a low coherence imaging method comprises acquiring image data of an object with an interferometric imaging system, where the image data is from a location of the object at first and second times; determining a first depth profile from the image data from the location at the first time and a second depth profile from the image data of the location at the second time; determining a change with respect to depth between the first and second depth profiles; and determining a property, or identifying a location, of at least one dynamic particle in the object based on the change between the first and second depth profiles.

Further, Pongchalee Pornthep et al. (2014), “Implementation and characterization of phase-resolved Doppler optical coherence tomography method for flow velocity measurement”, Proc. of SPIE, Vol. 9234, pp. 923416-1-923416-7 describe a system implementation and characterization of a Phase-Resolved Doppler Optical Coherence Tomography (PR-DOCT). The phase-resolved Doppler technique was implemented on a custom built Frequency Domain OCT (FD-OCT) developed at Suranaree University of Technology. Utilizing Doppler phase changed relation in a complex interference signal caused by moving samples, PR-DOCT can produce visualization and characterization of flow activity such as blood flow in biological samples. They report the performance of the implemented PR-DOCT system in term of the Velocity Dynamic Range (VDR), which is defined by the range from the minimum to the maximum detectable axial velocity. The minimum detectable velocity was quantified from a histogram distribution of phase difference between consecutive depth-scan signals when performing Doppler imaging of a stationary mirror. By applying a Gaussian curve fitting to the histogram, the Full Width at Half Maximum (FWHM) of the fitted curve was measured to represent the detectable minimum flow velocity of the system. The maximum detectable velocity was limited by the phase wrapping of the Doppler signal, which is governed by the acquisition speed of the system.

### SUMMARY OF THE INVENTION

Dynamic light scattering optical coherence tomography (DLS-OCT) relies on the fluctuations of scattered light intensity and coherence gating to obtain simultaneous depth-resolved information about diffusive and translational motion of particles. This information may be extracted from the temporal autocorrelation of the OCT signal for every voxel in depth. DLS-OCT is a widely used technique in flow imaging and particle sizing. The particle size may especially be determined from the through DLS-OCT estimated diffusion coefficient using the Stokes-Einstein relation.

Flow measurements with OCT are typically performed using phase-resolved Doppler OCT, lateral resonant Doppler OCT, and M-scan correlation analysis. The phase-resolved Doppler measurements are limited by phase wrapping due to large axial motion. In the correlation-based measurements, the velocity range depends on the maximum decorrelation rate due to a system acquisition rate and particle transit time, while the axial velocity is limited by interferometric fringe washout. When measuring particle diffusion under flow, uncertainty in the diffusion coefficient estimation rapidly increases with increasing flow speeds.

Hence, it is an aspect of the invention to provide an alternative method, which preferably further at least partly obviates one or more of above-described drawbacks. The present invention may have as object to overcome or ameliorate at least one of the disadvantages of the prior art, or to provide a useful alternative.

In a first aspect, the invention provides a method for determining a characteristic of a fluid by optical coherence tomography (OCT). In specific embodiments, the method comprises determining the characteristic of the fluid by Fourier domain optical coherence tomography (FD-OCT). The fluid may, in embodiments, be a flowing fluid. Further, the fluid is especially a turbid fluid. The fluid may comprise (one or more) particles. In further embodiments, the characteristic of the fluid is especially determined for the fluid (flowing) in a sample space. In further embodiments, the method comprises estimating a (local) velocity (νₑₛₜ) of the fluid (somewhere) in the sample space. Further, the method may comprise controlling an optical scanner to radiate a beam of (low coherence) (measurement) light along an optical path to the fluid (in the sample space). The (measurement) light may propagate along the optical path. Further, especially, the optical scanner is controlled to sense a signal (of interference) of (a part of the) (measurement) light scattered back along the optical path mixed (especially downstream of the sample space) with (reflected) reference (measurement) light. The backscattered light and the (reflected) reference light may especially interfere at a detector or sensor, sensing the signal. Therefore, herein the sensed signal may also be indicated as “signal of interference” or “interference signal”. The signal (of interference) especially comprises a wavelength spectrum of interference. The reference (measurement) light may especially have propagated along a predetermined reference optical path. Further, especially, the optical scanner is moved while sensing the signal. In embodiments, the optical scanner is moved while being controlled to radiate the beam of light and to sense the signal (of interference). In specific embodiments, the scanner is moved with a scanner velocity (ν_{b}) that is based on (e.g., “as a function of” or “relative to”) the (estimated) (local) velocity, νₑₛₜ, of the fluid. In specific embodiments, the scanner is moved with a scanner velocity (ν_{b}) corresponding to the (local) velocity, νₑₛₜ, of the fluid. In further specific embodiments, the scanner is moved with a scanner velocity (ν_{b}) corresponding to a (velocity) component of the (local) velocity, νₑₛₜ, of the fluid, especially a component of the (local) velocity perpendicular to a direction of the beam of light (or to the optical path). Further, especially, the beam of light is moved with a scanner velocity (ν_{b}) when moving the optical scanner (with the scanner velocity (ν_{b})). In further specific embodiments, the method comprises processing the (sensed) signal (of interference). In embodiments, the signal (of interference) (especially comprising a signal strength for each wavelength at time t) is processed into a corresponding complex-valued optical path length, z, resolved OCT signal a(t, z). In specific embodiments, the (complex) OCT signal represents the fluid in the sample space. In further specific embodiments, the sample space is defined by (at least part of) the optical paths scanned during moving the optical scanner. Further, especially, the optical scanner is an optical scanner of an OCT device, especially an FD OCT device. The scanner velocity may, in embodiments, (be selected to) correspond to (a value and/or direction of) the (local) velocity, νₑₛₜ, of the fluid. In yet further embodiments, the method (further) comprises determining the characteristic of the fluid based on the OCT signal a(t, z). In embodiments, the characteristic of the fluid comprises a diffusion coefficient of the (one or more) particles in the fluid. In further embodiments, the characteristic of the fluid (further) comprises a size (or mean size) of (one or more) particles (in the fluid). In further embodiments, the characteristic may comprise a shape of (one or more) of the particles (in the fluid). Additionally, or alternatively, the characteristic may comprise a particle size distribution (PSD) of particles in the fluid (or “distribution of particle sizes”, “PSD”). In yet further embodiments, the characteristic may relate to a velocity of the fluid (in the sample space), e.g., the characteristic may comprise a local velocity, νₗ (herein also indicated as “ν₀”), of the fluid, and/or a mean (or average) velocity, <ν>, of the fluid, especially in the sample space. The characteristic may further comprise a velocity profile of the fluid, especially in the sample space. In further specific embodiments, the characteristic of the fluid comprises one or more of a (mean) size of (one or more of) the particles in the fluid, a shape of (one or more of) the particles in the fluid, a diffusion coefficient (D) of (one or more of) the particles in the fluid, a particle size distribution (PSD) of (the) particles in the fluid, a local velocity, νₗ (ν₀), of the fluid, a velocity profile of the fluid in the sample space, and a mean velocity, <ν>, of the fluid in the sample space.

Herein, the local velocity “νₗ” is also indicated with “ν₀”.

The present method especially improves the maximum measurable velocity limit for analyzing (omnidirectional) flows and the lowest measurable diffusion coefficient of the particles (and based on that the largest measurable particle sizes). Especially, when scanning the OCT beam in the direction of the flow, the dynamic velocity range over which the characteristic (especially the diffusion coefficient) can be determined may significantly be increased. The method is capable of measuring a significant higher range of velocities than standard Doppler OCT, lateral resonant Doppler OCT or conventional DLS-OCT correlation analysis (M-scan) with a stationary beam. Maximum flow speeds that can be analyzed with the method may in embodiments be at least twice as large compared to the method wherein the scanner is not moved. By moving the scanner along the flow, higher flows can be measured, and even more advantageously, the diffusion under these higher flows (and/or for larger particles) may be measured. In case this would have been measured statically (in M-scan mode), any decorrelation used in the OCT methods would have been entirely dominated by flow. This effect is even more pronounced for larger particles than for smaller particles (especially larger particles may cause slower decorrelation). Estimating the (local) velocity enables to scan along the flow at any depth and locally reduce the decorrelation due to the flow. At a location near the wall, this difference may be less pronounced since the flow at the wall may be close to zero. However, at a location close to the wall also characteristics of the particles may deviate much from the characteristics of the particles remote from the wall (e.g., clusters of particles may be formed at the wall or particle sizes may differ from sizes remote from the wall). The method may further allow determining the characteristic at a location further remote from the wall compared to prior art method.

Hence, in an embodiment, the invention provides a method for determining a characteristic of a flowing fluid in a sample space by Fourier domain optical coherence tomography (FD-OCT), the fluid comprising particles, wherein the method comprises: estimating a velocity, νₑₛₜ of the fluid in the sample space; controlling an optical scanner, especially of an FD-OCT device, to radiate a beam of light along an optical path to the fluid in the sample space and to sense a signal (of interference) of (i) (part of the) light scattered back along the optical path mixed with (ii) reference reflected light, while moving the optical scanner, wherein the beam of light is moved with a scanner velocity, ν_{b} being aligned with a velocity component of the velocity νₑₛₜ of the fluid perpendicular to the optical axis of the beam of measurement light; processing the (sensed) signal into a corresponding complex-valued optical path length, z, resolved OCT signal, a(t, z), wherein the OCT signal a(t, z) represents the fluid in the sample space, and determining the characteristic of the fluid based on the OCT signal a(t, z), wherein the characteristic of the fluid comprises one or more of a size of one or more of the particles in the fluid, a shape of one or more of the particles in the fluid, a diffusion coefficient of one or more of the particles in the fluid, a particle size distribution (PSD) of particles in the fluid, a local velocity, νₗ, of the fluid, a velocity profile of the fluid in the sample space, and an mean velocity, <ν>, of the fluid in the sample space.

The method may especially comprise dynamic light scattering (DLS) optical coherence tomography (OCT). DLS may also be referred to as photon correlation spectroscopy (PCS). The method further especially comprises moving the optical scanner with a predetermined velocity while analyzing the sample space. The method may, in embodiments, be referred to as a B-scan correlation-based DLS-OCT. Especially, the method may comprise a frequency domain (or Fourier domain) optical coherence tomography (FD-OCT).

The method is essentially a non-invasive method. The fluid flow may be analyzed when flowing in a (flowing) space, or “sample space”. The term “space” in “sample space” or “flowing space” may refer to a (predetermined) volume. The fluid may flow in, or through, this volume when being analyzed. The sample space may be comprised of any arbitrarily container or holder that may (temporarily) host the flowing fluid. Embodiments of such container or holder are, e.g., piping, tubing, a channel, a vessel, a beaker, or for instance a rheometer. Herein, the term container may be used for any element that may host the fluid, especially where the fluid may flow through and/or in. The container or holder is especially at least partly transmissive for the measurement light. The container may have a wall that is at least partly transmissive for the measurement light. In embodiments, at least part of the measurement light may propagate into (and out of) the container, especially via the wall. For instance, in embodiments, the fluid may flow through a channel comprising a (measurement) light transmissive, or “transparent” wall. The wall may comprise a transparent part, or (measuring) window configured transmissive for the measurement light. The fluid may in embodiments be analyzed via the window. It may thus not be required to extract the fluid from the (sample) space to analyze the fluid.

Herein the term “fluid” may refer a gaseous fluid and/or a liquid fluid. The term especially refers to a liquid. The term “fluid” may refer to a Newtonian fluid. The term may refer to a non-Newtonian fluid. The fluid may, in embodiments comprise a gel. The fluid may comprise a slurry. The fluid may further comprise a paste. The fluid may comprise a bodily fluid, such as blood. The term “fluid” may in embodiments refer to a complex fluid. The term may refer to a mixture of different fluids and/or different phases. The term may in further embodiments refer to a fluid comprising (the) particles. The fluid may in embodiments comprise a suspension or dispersion (of particles in a fluid, especially in a liquid).

The fluid may further comprise (one or more) particles. The particles may in embodiments have a dimension or size (e.g., width, length, or diameter) in the nanometer range, such as at least 1 nm, e.g. in the range of 1-1000 nm, especially 1-100 nm. In further embodiments, the dimension or size may at least be 10 nm. The particles may further have the dimension (size) in the micrometer range, such as up to 100 micrometers, especially up to 10 micrometers. In embodiments, the particles are nanoparticles. The size of the particles may especially be selected in the range of 1 nm to 500 μm, such as 1 nm-100 μm, especially 10 nm-100 μm, such as 10 nm-10 μm. In further embodiments, the size of the particles may especially be selected in the range 1-1000 nm, such as 1-100 nm.

The term “particles” may refer to, or comprise, solid particulate material. The term may refer to colloidal particles. The term “particles” may further (also) refer to bubbles, such as gaseous bubbles and/or liquid bubbles (e.g., in a fluid comprising an emulsion). The term “particle” may refer to a (macro) molecule. The macro (molecule) or colloid particle may especially be a collection of a plurality of sub particles. Further, the term “particle” may refer to a plurality of (different) particles. Moreover, the term particle(s) may in embodiments refer to a type of particle(s), especially to a plurality of different types of particles. Further, the term “particle” may refer to a plurality of (different) particles. The term “particles” may refer to one or more particles or a cluster of (especially the same) particles.

Furthermore, the phrase “characteristic of a fluid” may refer to a characteristic of the fluid as such. It may further refer to a characteristic of one or more (structural) elements such as particles and/or bubbles in the fluid. The characteristic may (also) refer to a characteristic of a combination of the fluid and the particles. The term characteristic may, e.g., especially relate to a diffusion coefficient of the particles in the fluid. The characteristic (of the fluid) may (thus) also comprise the size of a particle or a velocity of a particle. Additionally, or alternatively, the characteristic may comprise a velocity of the fluid (surrounding the particle). The characteristic of the fluid may comprise a (characteristic) size of the one or more particles in the fluid. The characteristic of the fluid may comprise a particle size distribution (PSD) of particles in the fluid. The characteristic of the fluid may further comprise a mean size of particles in the fluid, such as a number-averaged particles size. The characteristic of the fluid may comprise a shape of one or more particles in the fluid.

The (characteristic) size may depend on a type of a particle. For instance, the term “size” may refer to a diameter of a spherical particle. Further, the “size” may also refer to a smallest dimension and/or a largest dimension on any arbitrarily shaped particle. The term may refer to a hydrodynamic diameter. The term “hydrodynamic diameter” (of a particle, especially a (macro) molecule) is known to the skilled person and refers to a diameter of a perfect solid spherical particle that would exhibit a same hydrodynamic friction as the particle of interest. For non-spherical particles, the size may further be defined by the Sauter mean diameter, also indicated by d_{3,2}, referring to diameter of a sphere that has the same volume/surface area ratio as the particle of interest.

The characteristic of the fluid may further comprise a local (fluid) velocity, νₗ, of the fluid (and/or of a particle). The characteristic of the fluid may comprise a velocity profile of the fluid in the sample space. Further, the characteristic of the fluid may comprise a mean velocity, <ν>, of the fluid (and/or the particles) in the sample space. The characteristic of the fluid may change over time (yet may, in embodiments, be assumed to be constant during a measurement). The characteristic of the fluid may relate to a location in the sample space. Especially, the characteristic may have a spatial and/or a temporal component. The characteristic may in embodiments refer to a spatio-temporal characteristic.

The term “characteristic” (of the fluid) may refer to a plurality of different characteristics (such as described herein). Different characteristics may further relate to each other. For instance, the local velocity of the fluid at a location may relate to the velocity of a particle surrounded by the fluid at said location. Further, based on the diffusion coefficient (as a characteristic of the fluid), e.g., the size of the particles (being another embodiment of a characteristic of the fluid) may be determined using the using the Stokes-Einstein relation. The characteristic may in further specific embodiments comprise a rotational motion or diffusion of a particle. Further, a non-spherical shape of a particle may be concluded based on a rotation of the particle. When the particle is non-spherical, it especially causes additional fluctuations in the scattered field. These may give rise to additional decorrelation in the OCT signal, which can be quantified to determine a rotational diffusion.

Herein, the term “velocity” may relate to a vector quantity. The term may in embodiments refer to a velocity in three dimensions. The term especially relates to a direction (i.e., a vector) in combination with a speed (i.e., a scalar quantity) (also indicated as “value” or “magnitude” of the velocity). The term may further refer to the speed (only). Further, the term “local velocity” (of the fluid) especially refers to the velocity at a specific location or position (in the sample space). The local velocity at a first location and the local velocity at a second location may therefore differ in direction and/or in magnitude, especially in magnitude (“speed”), from each other. For instance, the fluid at a location of the wall of a channel may have a zero velocity (under no-slip conditions), whereas the fluid in a center of a channel may have a first velocity with a direction substantially parallel to the channel and the fluid at a location between the center and the wall may have a speed lower than the first velocity and a similar direction as the first velocity (under laminar flow conditions).

The estimated velocity especially refers to a local velocity. The estimated velocity may therefore comprise an estimation of a local velocity at any location in the sample space. In embodiments, the estimated velocity may be estimated at a location remote from a center of the samples space, such as near to the wall of the container comprising the sample space. In embodiments, the estimated velocity is estimated as a mean velocity of a highest local velocity (such as in a center of the sample space) and a lowest local velocity (such as at the wall) in the sample space (i.e., (highest local velocity−lowest local velocity)/2). In further embodiments, the estimated velocity is especially estimated at a center of the sample space. Moreover, the estimated velocity may be estimated at a plurality of positions. Especially, based on estimated velocity at the plurality of positions, the scanner velocity may be set. The velocity may especially be estimated to facilitate quantifying diffusion of the particles in the fluid. Moving the scanner based on the estimated velocity especially allows scanning along at any depth and may locally reduce the decorrelation due to the flow (see also above). The velocity may be estimated at a location relevant for analysis.

The mean velocity, <ν>, especially refers to an average velocity of the fluid, more especially to an average value (or speed) of the average velocity of all (discrete) fluid elements. The average velocity of a fluid element is especially a ratio of [the displacement over a displacement period] to [the displacement period]. The mean velocity <ν> may further be defined as a ratio of a flow rate of the fluid in the sample space over a cross section (cross sectional area, or “flow-through area”) of the sample space. For instance, for a channel having a channel cross section (perpendicular to an axis (of elongation) of the channel), the mean velocity may be defined as the ratio of the volume flow rate of the fluid (in the channel) to the channel (inner) cross section (al area). Moreover, in a straight channel, a direction of the mean velocity may correspond to the flow direction.

The term velocity profile may refer to a graph of the speed of a fluid flow as a function of a distance perpendicular to the direction of flow. The velocity profile is especially a result of a friction between layers of the fluid and/or between a layer of the fluid and a stagnant part, such as a wall of the container comprising the sample space, e.g., a wall of the channel, see also above with respect to the local velocity.

The method is based on optical coherence tomography (OCT). Optical coherence tomography is an imaging technique using low-coherence light to provide micrometer-resolution images. Two- and three-dimensional images may be determined from within optical scattering media (such as a turbid liquid). The light or “measurement light” is irradiated as a beam to the sample space along an optical path and may be backscattered by the fluid in the sample space along the same optical path to (a) sensor(s) or detector(s). The sensor may be comprised by the scanner. Herein, the method is explained by a system wherein the beam is provided by the scanner and the reflected light is sensed by the scanner. It will be understood that structurally different elements may be used and the light source providing the beam of light not necessarily is part of the scanner. The OCT device may, e.g., comprise a light generating element configured to provide the beam of light. The light generating element may be part of the scanner, but, e.g., may also be configured remote from the scanner. Also, the sensor or detector for sensing the signal not necessarily is (an integrated) part of the scanner. Again, the scanner may comprise a detector and/or sensor. Yet, the detector and/or sensor may in further embodiments be configured remote from the scanner. Essentially, the (measurement) light and the back scattered light propagate substantially along the same optical path, see further below. Yet, the light generally is generated at another location than it is sensed. Moving the scanner, especially refers to moving some elements of the OCT device such that the optical path is moved. Moving the scanner may especially imply that the beam is moved with the scanner velocity (or beam velocity) ν_{b}. The term “scanner” is especially used to indicate that during use, a position in the sample space that is analyzed is gradually changed or “scanned”.

OCT is used for medical imaging and may also be used for nondestructive testing of optical scattering media. The technique often employs near-infrared light; yet other types of light may be used as well. The use of relatively long wavelength light allows it to penetrate into the scattering medium. The measuring light may be provided by different light sources. Examples of light sources that may be used are: superluminescent diodes, ultrashort pulsed lasers, or a supercontinuum laser. In conventional interferometry with long coherence length (e.g., laser interferometry), interference of light occurs over a distance of meters. In OCT, this interference is shortened to a distance of micrometers, especially based on the use of broad-bandwidth light sources, i.e., light sources that emit light over a broad range of frequencies. White light is an example of broadband light.

The (measurement) light in an OCT system is often divided into two arms, i.e., a sample arm comprising or irradiating a sample to be analyzed and a reference arm. The reference arm usually comprises a mirror. The combination of reflected light from the sample arm and reference reflected measurement light from the reference arm gives rise to an interference pattern (at the sensor), if light from both arms have traveled an (optical) distance, that especially differs less than a coherence length from each other. By scanning the mirror in the reference arm, a reflectivity profile of the sample may be obtained (this is also called time-domain OCT). Areas of the sample that scatter back a lot of measurement light will create greater interference than areas that don't. Any light that is outside the short coherence length may not interfere. This reflectivity profile is often called an A-scan and especially comprises information about the spatial dimensions and location of structures, such as particles, within the sample space. A cross-sectional tomograph may be achieved by laterally combining a series of (axial) depth scans (A-scan).

In time domain OCT (TD-OCT), the optical pathlength of the reference arm may be varied in time, (e.g., by translating the mirror longitudinally (in the reference arm)). As described above, typically, the interference, e.g., visualized as a series of dark and bright fringes, is only achieved when the path difference lies within the coherence length of the light source. This interference is called auto correlation, especially in a symmetric interferometer (wherein both arms have the same reflectivity). Alternatively, the term cross-correlation may be used for general interferometers. The envelope of this modulation changes as pathlength difference is varied, where the peak of the envelope corresponds to pathlength matching.

In frequency domain OCT (FD-OCT), also known as Fourier domain OCT, a broadband interference may be acquired with spatially separated detectors or sensors. The method especially comprises FD-OCT. Two commonly known approaches that may be used in the method are swept-source OCT and spectral-domain OCT. A swept-source OCT encodes the optical frequency in time with a spectrally scanning source. A spectral-domain OCT uses a dispersive detector, like a grating and a linear detector array, to separate the different wavelengths. Based on a Fourier relation between the interference signal and the depth scan, the depth scan can directly be calculated by a Fourier-transform from acquired spectra, without movement of the reference arm. In this way the speed of the measurement is greatly increased compared to TD-OCT. Herein, the method especially uses (or better, is explained using) FD-OCT. Alternatively TD-OCT may be used. The skilled person will understand how to perform the method using TD-OCT based on the explanation of the method in the present specification.

The measurement light may comprise a center wavelength λ_{c} and a bandwidth of Δλ, especially having a Full Width Half Maximum (FWHM). The measurement light is especially low (temporal) coherence light enabling to create a spatial “coherence gate” of interference by which the final backscattered measurement light (mixed with the reference light) can be resolved for specific path length. Typical values for λ_{c} and Δλ may be in the range of 300-2000 nm, such as 500-1500 nm, and a few hundred nm, especially at least 50 nm, respectively.

The (sensed) signal of interference of light scattered back along the optical path and the reference reflected light may comprise a spectrum I(t, λ) at time t and wavelength λ.

The signal I(t, λ) sensed for each wavelength of the measurement light (the spectrum at time t) is the result from interference at the sensor(s) (or detector(s)) of light (electromechanical waves) scattered back from the fluid, especially from the particle(s) in the fluid, and light reflected as reference reflected light. Based on motion of the particles (e.g., Brownian motion and/or motion with or in the fluid), the interference signal I(t, λ) shows temporal fluctuations characteristic for the motion of the particles (and surrounding fluid). The optical path length resolved OCT signal a(t, z) may be determined from the signal I(t, λ). The method may comprise several processing steps to yield the optical path length resolved (OCT) signal a(t, z) from the interference signal. It is noted that in embodiments the actual OCT signal a(t, z) may be the complex Fourier transform of I(t, k), wherein k is the wave number defined as k=2π/λ. For a specific scattering, a specific optical path length z represents a specific distance in the fluid (depth) and temporal fluctuations of a(t, z) result from the motion of the particle(s) in a coherence volume (or “voxel”) at that location (distance).

Obtaining the OCT signal a(t, z) based on the signal of interference may comprise deriving the (complex-valued) (time, t, and) optical path length, z, resolved OCT signal, a(t, z), from a time-resolved OCT wavelength spectrum of interference.

A maximum velocity of the particles and/or a maximum size of the particles that may be determined may be limited. It is an aspect of the invention to circumvent this limitation. In the presently described method, the scanner is especially moved along with the fluid flow to increase this maximum velocity or size and to improve prior art methods. The scanner velocity ν_{b} may especially be selected close to the (local) fluid velocity resulting in an “effective” velocity being based on a difference between the fluid velocity and the scanner velocity. The effective velocity may especially be based on a difference between the directions and values of the respective velocities. Hence, especially for expanding the (diffusion) analyses to higher fluid velocities or larger particle sizes, νₑₛₜ may relate to the estimated velocity of the fluid at a location being analyzed, and ν_{b} may be set substantially equal to νₑₛₜ. It will be understood that under normal conditions, the fluid may comprise particles at different locations in the sample space, having different velocities. Therefore, the scanner velocity may be set at different speeds (and directions) depending on the location of interest (comprising the particle scattering back the light). The velocity may especially be set to a value between a maximum fluid velocity and a minimum fluid velocity in the sample space. The scanner velocity may in embodiments be set to a mean value of a maximum fluid velocity and a minimum fluid velocity in the sample space (see also above).

The term “a velocity” in relation to the estimated velocity νₑₛₜ such as in phrases like of “an estimated (local) velocity of the fluid” may refer to a plurality of different velocities. For instance, in embodiments, the scanner velocity may be based on a plurality of fluid velocities at multiple locations.

In specific embodiments, the method may comprise (inverse) Fourier transformation to yield the complex (or complex-valued) optical path length resolved (OCT light scattering) signal a(t, z). Herein, the term “complex” may sometimes be omitted. Phrases like “optical path length resolved signal a(t, z)”, “optical path length resolved OCT light scattering signal a(t, z)”, “optical path length resolved OCT signal”, “signal a(t, z)”, etc., may in embodiments refer to the same signal and especially to the “complex optical path length resolved signal a(t, z)”, “complex optical path length resolved OCT light scattering signal a(t, z)”, “complex(-valued) signal a(t, z)” and the like. Starting from the complex-valued signal a(t, z), analyses may be performed based on a real part of a(t, z), indicated as Re(a) or real(a); an imaginary part of a(t, z), indicated as Im(a(t, z)), Im(a), imag(a(t, z)), imag(a); a magnitude or modulus of a(t, z), indicated as |a| or |a(t, z)|; or an intensity of a(t, z), indicated as |a|² or |a(t, z)|².

Hence, in embodiments, the method may especially comprise performing a Fourier-transformation to a spatial domain on a spectral intensity (I(t, k)) of the (sensed) signal (of interference) to provide the complex-valued optical pathlength resolved OCT signal, a(t, z), with k being the wave number defined as k=2π/λ, and especially with λ being a wavelength of the signal of interference. Alternatively, directly the wavelengths may be used in the time domain.

In specific embodiments the characteristic of the fluid is determined based on a first-order autocovariance of the complex-valued OCT signal, especially of amplitudes of the complex-valued OCT signal. In embodiments, the characteristic may be based on the first order autocovariance of one or more of real values of amplitudes of the complex-valued OCT signal, magnitudes of the complex-valued OCT signal, and intensities of the complex valued OCT signal.

In further specific embodiments, determining the characteristic of the fluid based on the OCT signal a(t, z), comprises determining an autocorrelation function of the OCT signal a(t, z), especially in a time domain. In further embodiments, determining the characteristic of the fluid based on the OCT signal a(t, z) comprises determining a frequency power spectrum of the OCT signal a(t, z), especially in the temporal frequency domain.

Determining the autocorrelation function may, in embodiments, comprise determining a decorrelation rate of the OCT signal to determine the characteristic of the fluid. The decorrelation rate may especially be determined on amplitudes in OCT signal, especially in a power spectral density. Moreover, in embodiments, the autocorrelation may be replaced by the autocovariance after subtracting mean values of the OCT signal.

Hence, in embodiments, the method comprises transforming the raw interference signal or spectrum (the interference signal strength for each wavelength at time t) into the corresponding optical path length resolved (complex) OCT signal a(t, z). As described above, such processing may comprise several steps. The transformation may, e.g., comprise background noise subtraction and further processing steps like (inverse) Fourier transformation.

In further specific embodiments, the autocorrelation function of the OCT signal in the time domain comprises a z-resolved temporal autocorrelation function, G(τ, z), of a(t, z), in which τ represents a lag time. Further, especially the frequency power spectrum of the interference signal in the spectral domain comprises a z-resolved frequency power spectrum, Ĝ(ω, z), of a(t, z), in which ω represents an angular frequency.

In embodiment, determining the characteristic of the fluid based on the autocorrelation function of the OCT signal may comprise determining, from G(τ, z), z- and τ-dependent decorrelation factors, g_{F}(t, z), related to a flow of the fluid. The function g_{F}(τ, z) especially relates to a flow of the fluid relative to the scanner, especially based on the effective velocity, which is the local fluid speed minus the local scan speed. Additionally, or alternatively, determining the characteristic of the fluid based on the autocorrelation function of the OCT signal may comprise determining, from G(τ, z), z- and τ-dependent autocorrelations, g_{B}(τ, z), representative of Brownian motion of the more particles. In further embodiments, determining the characteristic of the fluid based on the autocorrelation function of the OCT signal comprises determining, from G(τ, z), a characteristic optical path length, Zₛₛ, representative of a photon mean free path in the flowing fluid, for which g_{B}(τ, z) for z<Zₛₛ in the flowing fluid are independent of z within a measurement noise. In yet further embodiments, determining the characteristic of the fluid based on the autocorrelation function of the OCT signal comprises determining, based on g_{B}(τ, z) for z<Zₛₛ in the flowing fluid, an averaged autocorrelation function, <g_{B}(τ)>, representative of single scattered measurement light, and performing a dynamic light scattering (DLS) analysis (or “photon correlation spectroscopy (PCS) analysis”) using <g_{B}(τ)> to extract information related to the characteristic of the fluid.

Further, especially determining the characteristic of the fluid based on the frequency power spectrum of the OCT signal may comprise determining, from Ĝ(ω, z), z-resolved power spectra, ĝ_{F}(ω, z), related to the flow of the fluid. The function ĝ_{F}(ω, z) especially relates to the flow of the fluid relative to the scanner, especially based on the effective velocity. Additionally, or alternatively, determining the characteristic of the fluid based on the frequency power spectrum of the OCT signal may comprise determining, from Ĝ(ω, z), z-resolved power spectra ĝ_{B}(ω, z) representative of Brownian motion of the particles. In further embodiments, determining the characteristic of the fluid based on the frequency power spectrum of the OCT signal comprises determining, from Ĝ(ω, z), a characteristic optical path length, Zₛₛ, representative of the photon mean free path in the flowing fluid, for which ĝ_{B}(ω, z) for z<Zₛₛ in the fluid are independent of z within the measurement noise. In yet further embodiments, determining the characteristic of the fluid based on the frequency power spectrum of the OCT signal may comprise determining, based on ĝ_{B}(ω, z), for z<Zₛₛ in the flowing fluid, an averaged power spectrum, <ĝ_{B}(ω)>, representative of single scattered light, and deriving, from <ĝ_{B}(ω)>, information related to characteristic of the fluid.

For a flowing fluid, the temporal autocorrelation function G(τ, z) may be approximated by:

$$G ( τ , z ) = γ ( z ) {g}_{B} ( τ , z ) {g}_{F , x} ( τ , {v}_{x} ( z ) ) {g}_{F , z} ( τ , {v}_{z} ( z ) ) , with {g}_{F , x} = {e}^{- {( {Γ}_{x} ( z ) τ )}^{2}} .$$

In the formula g_{B}(τ, z) especially represents Brownian motion related to a particle size (distribution). The term g_{F,x}(τ, νₓ(z)) relates to transverse flow characterized by a Gaussian beam with decay rate Γₓ(z)=νₓ(z)/w, wherein νₓ(z) is the local transverse velocity (relative to the (also moving) beam or optical path) and w the effective beam waist at focus (being dependent on the OCT device). The term g_{F,z}(τ, z) reflects the flow along the optical axis. Alternatively, in further embodiments the modulus |a(t, z)| of a(t, z) may be used, and the remainder of the method may be the same.

The Brownian motion may be used to calculate the diffusion coefficient. The method may in embodiment comprise determining a diffusion coefficient (especially based on the Brownian motion) of one or more particles from the autocorrelation function of the OCT signal and/or from the frequency power spectrum of the OCT signal and calculating the size of the particle from the diffusion coefficient. The particle size may, e.g., be calculated based on the Stokes-Einstein equation relating the diffusion coefficient to the radius of the particle. In further embodiments the method may comprise determining the distribution of particle sizes using a function representing a distribution of rates. The distribution of sizes can be determined using an inverse Laplace transform or multi-exponential fitting.

In further embodiments, the method further comprises calculating the particle size distribution of a plurality of particles from sizes calculated for the respective particles (especially comprising comprise multi-exponential fitting).

Hence, in embodiments, the autocorrelation function of the OCT signal in the time domain comprises a z-resolved temporal autocorrelation function, G(τ, z), of a(t, z), in which τ represents a lag time, and wherein the frequency power spectrum of the interference signal in the spectral domain comprises a z-resolved frequency power spectrum, Ĝ(ω, z), of a(t, z), in which ω represents an angular frequency;
wherein determining the characteristic of the fluid based on the autocorrelation function of the interference-signal comprises one or more of:
   Determining, from G(τ, z), z- and τ-dependent decorrelation factors, g_{F}(τ, z), related to a flow of the fluid;
   determining, from G(τ, z), z- and τ-dependent autocorrelations, g_{B}(τ, z), representative of Brownian motion of the one or more particles;
   determining, from G(τ, z), a characteristic optical path length, Zₛₛ, representative of a photon mean free path in the flowing fluid, for which g_{B}(τ, z) for z<Zₛₛ in the flowing fluid are independent of z within a measurement noise; and
   determining, based on g_{B}(τ, z) for z<Zₛₛ in the flowing fluid, an averaged autocorrelation function, <g_{B}(τ)>, representative of single scattered measurement light, and performing a DLS (or photon correlation spectroscopy (PCS)) analysis using <g_{B}(τ)> to extract information related to the characteristic of the fluid; and
wherein determining the characteristic of the fluid based on the frequency power spectrum of the OCT signal comprises one or more of:
   determining, from Ĝ(ω, z), z-resolved power spectra, ĝ_{F}(ω, z), related to the flow of the fluid;
   determining, from Ĝ(ω, z), z-resolved power spectra ĝ_{B}(ω, z), representative of Brownian motion of the particles;
   determining, from Ĝ(ω, z), a characteristic optical path length, Zₛₛ, representative of the photon mean free path in the flowing fluid, for which ĝ_{B}(ω, z) for z<Zₛₛ in the fluid are independent of z within the measurement noise; and
   determining, based on ĝ_{B}(ω, z), for z<Zₛₛ in the flowing fluid, an averaged power spectrum, <ĝ_{B}(ω)>, representative of single scattered light, and deriving, from <ĝ_{B}(ω)>, information related to characteristic of the fluid.

In embodiments the term “the flow of the fluid” may refer to the flow of the fluid relative to the scanner (movement), especially based on the difference between the fluid velocity and the scanner velocity (said difference herein also being indicated as effective velocity).

Further, it is noted that the method may especially comprise fitting an entire model to data of the OCT signal to solve for the velocity profile with a least-squares approach. This method is applicable when the small angle approximation between the flow and scanning vectors is not valid. Here, the additional fitting parameters can be φₜ, φ_{z} and even θ. For obtaining sufficient data when using this approach, measurements are in embodiments performed at multiple scan speeds and/or scan angles.

Further, the method (especially comprising a B-scan mode while acquiring A-scans), may in embodiments comprise repeatedly determining a temporal autocorrelation of the OCT signal in the time domain and/or a temporal frequency power spectrum of the OCT signal in the spectral domain for voxels in the sample space that are (temporarily) irradiated with the measurement light, while moving the optical scanner. In embodiments, an optical axis of the beam of the measurement light may be provided perpendicular to (the wall of the container comprising) the samples space. The optical axis may be configured perpendicular to a direction of flow of the fluid in the sample space.

In further embodiments, the optical axis of the beam of measurement light may be configured obliquely with respect to the sample space (or the wall of the container comprising the sample space). The scanner velocity ν_{b} and the mean velocity <ν> of the fluid in the sample space may, in specific embodiments, define a non-zero angle (α).

Further, in specific embodiments, the scanner may be moved aligned with the (overall) direction of flow of the fluid. The scanner is especially moved parallel to the sample space. Yet, in further embodiments, the scanner also is especially moved in any arbitrarily way (in 3D) relative to the overall flow direction of the fluid. The scanner may further in specific embodiments be moved in a direction being aligned with a velocity component of the velocity νₑₛₜ (of the fluid) perpendicular to an optical axis of the beam of measurement light. The scanner, especially the beam of light, is especially moved in a plane perpendicular to the beam of light The scanner is further especially moved along a (straight) line. The line may in embodiments be a straight line, especially if the sample space comprises a straight sample space, such as a straight channel. In further embodiments, the line may be a curved line, especially in embodiments wherein the sample space is curved.

Further, especially, if the scanner direction and the overall flow direction of the fluid define an oblique angle, the method may comprise numerically aligning the optical path length resolved OCT signals a(t, z). If a distance between the wall of the container changes while moving the scanner, the optical path length for coherence volumes at a specific depth or distance from the wall of the container may also change. Using numerical aligning, signals determined for a given optical path length z may be translated along the axial direction (by increasing or decreasing the value of z) such that after aligning each (translated) optical path length for each t-value correspond to a specific physical depth in the channel or distance to the wall. Numerically aligning may facilitate processing the OCT signal if the optical path length z changes relative to the depth in the samples space when moving the scanner.

In embodiments, aligning the optical path length resolved OCT light scattering signals a(t, z) may comprise translating respective a(t, z) signal values along their optical paths relative to each other, such that for a first range of optical path lengths z₀ to z₁ indicative for a presence of fluid (in the sample space) at a first time t₁ and a second range of optical path lengths z₂ to z₃ indicative for the presence of fluid at a second time t₂ (in the sample space), z₂ and z₀ are substantially equal and z₀ and z₃ are substantially equal. Numerical alignment may especially comprise a spatial shift of the optical path length resolved OCT light scattering signals a(t, z) in the depth domain (along the z-axis).

Further, numerically aligning is especially performed prior to determining the autocorrelation function of the interference signal and/or prior to determining the frequency power spectrum of the interference signal.

Hence, in further embodiments, wherein the scanner is moved in the scanner direction being aligned with a velocity component of the velocity (νₑₛₜ) of the fluid perpendicular to the optical axis and wherein the scanner direction and an overall flow direction of the of the fluid (in the sample space) define an oblique angle (α), the method further comprises numerically aligning the optical path length resolved OCT light scattering signals a(t, z) by translating respective a(t, z) signal values along their optical paths relative to each other (in a z-direction parallel to the (respective) optical path), such that for a first range of optical path lengths z₀ to z₁ indicative for a presence of fluid (in the sample space) at a first time t₁ and a second range of optical path lengths z₂ to z₃ indicative for the presence of fluid at a second time t₂ in the sample space, z₂ and z₀ are substantially equal and z₀ and z₃ are substantially equal, wherein numerically aligning is performed prior to determining the autocorrelation function of the OCT signal and/or prior to determining the frequency power spectrum of the OCT signal.

In embodiments, numerically aligning comprises (inverse) Fourier transforming of the interference signal and successively spatially shifting the OCT signal. Alternatively, numerically alignment comprises applying a phase multiplication of the signal of interference in a frequency domain and successively (inverse) Fourier transforming the phase multiplied signal of interference.

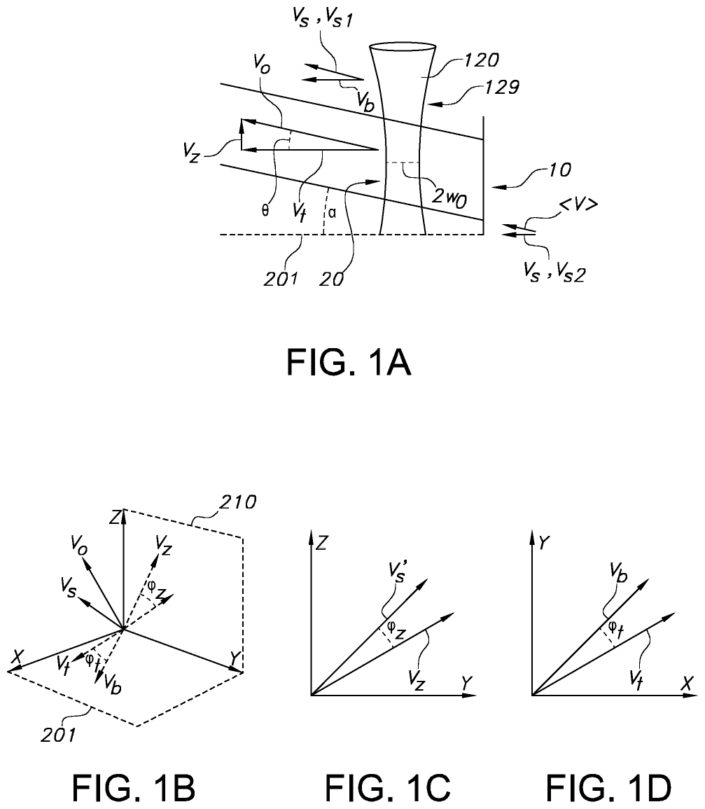

In the depth-domain, the spatial shift may be accomplished by circularly shifting depth voxels by an integer number M (t) as a function of time t according to:

$$M ( t ) = nint ( \frac{{nv}_{b} t tan ( α )}{{δ}_{z}} ) , a ( {z}_{i} , t ) ⇒ a ( {z}_{i + M ( t )} , t ) ,$$

where t is the acquisition time, α is a physical flow cell tilt angle, δ_{z} is the voxel size interval, ν_{b} is the (physical/actual) scanner (or beam) velocity, and νₛ is the effectively scan(ned) speed in the fluid flow, i.e. a projection of the scanner velocity ν_{b} onto the fluid flow direction (see FIGS. 1B-1D). The rounding operation nint (nearest integer function) is necessary as the voxels can only be shifted by an integer number. Depending on the scanning direction, the voxels are shifted upwards or downwards. An equivalent result may be obtained in the frequency domain using:

$$a ( k , t ) ⇒ a ( k , t ) {e}^{- 2 {iknv}_{b} ttan ( α )} , a ( k , t ) {\to }^{{ℱ}^{- 1}} a ( z , t ) .$$

After aligning the scanning and flow directions, the effective scan speed, νₛ may be expressed as νₛ=ν_{b}/cos(α).

In yet further embodiments, the method further comprising normalizing the optical path length resolved OCT signals a(t, z) before numerically aligning the optical path length resolved OCT signals a(t, z). Normalizing may, e.g., comprise adjusting the optical path length resolved OCT signals a(t, z) for a confocal point spread function (z) or normalizing the optical path length resolved OCT signal a(t, z) based on an average optical path, z, resolved amplitude signal, especially averaged over a plurality of B-scans, especially over the time t.

As discussed above, the fluid velocity may be estimated for a predetermined location in the sample space. The scanner velocity may especially be selected for minimizing a difference between a velocity of the particle(s) to be analyzed at the predetermined location and the scanner velocity. Therefore, the velocity of the fluid dragging the particle(s) along may, in embodiments, be estimated. In embodiments, it may be relevant to estimate the fluid velocity at the predetermined location and set the scanner velocity equal to this estimated velocity. In further embodiments, it may be relevant to determine a mean fluid velocity in the sample space and especially set the scanner velocity substantially equal to the mean fluid velocity. In yet further embodiments a fluid flow profile in the sample space may be estimated, and especially the scanner velocity may be based (or set equal to) on one or more velocities of the fluid flow profile, e.g., to a velocity near the wall of the container or a velocity near a stirrer in a stirred vessel, or halfway between the minimum and maximum (local) flow (rate). Herein, the phrase “moving the scanner with a scanner velocity based on the estimated velocity of the fluid” and the like may refer to any one of these options, or to even further options, especially to minimize the difference between the fluid velocity and the scanner velocity at one or more specific locations in the sample space. In further embodiments, the fluid velocity may be estimated based on prior analysis of the fluid flowing in the sample space. The method may in embodiments comprise estimating the velocity νₑₛₜ based on modelling the fluid flow through the samples space. Additionally, or alternatively, the method may comprise estimating the velocity νₑₛₜ based on one or more prior analyses of (the same or comparable) fluids flowing in the sample space.

In embodiments, the fluid velocity νₑₛₜ is especially based on (assuming) a laminar flow profile of the fluid in the sample space. Further, in embodiments, the flow profile and local fluid velocity may be estimated based on a total fluid flow through the samples space and (especially divided by) a flow through area of the sample space. The flow profile may depend on the geometry of the sample space. Yet, independently of the geometry, a mean velocity of the fluid may be estimated based on the throughput and the flow-through area. Further, a local velocity may be estimated based on the mean velocity and an estimated flow profile. In embodiments, the fluid may flow through a channel comprising the sample space. In such embodiments, e.g., a mean velocity <ν> of the fluid may be defined as the ratio of the fluid volume flow rate through the channel over the flow-through area of the channel. Further for laminar flow, local fluid velocities may be determined based on a laminar flow profile of the fluid in the channel.

In embodiments, a ratio of a magnitude (absolute value) of the scanner velocity ν_{b} (or “speed”) and a magnitude of the velocity νₑₛₜ of the fluid (“speed”) may be in the range of 0.0-10, especially in the range of 0-5. The scanner velocity may in embodiments be in the range of 0.0-16 mm/s. The scanner velocity is especially non-zero. The ratio of the magnitude of the scanner velocity (ν_{b}) and a magnitude of the velocity (νₑₛₜ) of the fluid may in embodiments be is in the range of 0.1-10. Said ratio may be at least 0.05, such as at least 0.1. In embodiments, the ratio of the magnitude of the scanner velocity (ν_{b}) and a magnitude of the velocity (νₑₛₜ) of the fluid is in the range of 0.1-1. The ratio may especially be equal to or smaller than 1. Further, a direction of the movement of the scanner may be set to differ from a direction of the fluid (or particle) (at the predetermined location). In specific embodiments the beam of light is moved with a velocity (ν_{b}) along a direction of a component (or fluid element) (with magnitude νₑₛₜ) of the fluid flow such that this velocity component relative to that of the scanner velocity is lower than the velocity component in a static frame (i.e. if the beam of light is not moved), and especially wherein a ratio of a magnitude of the scanner velocity (ν_{b}) and a magnitude of the velocity (νₑₛₜ) of the fluid is in the range of 0.1-10.

Hence, in embodiments of the method, the fluid is flown through a channel comprising the sample space, and estimating the (local) velocity νₑₛₜ of the fluid in the sample space comprises: determining a mean velocity <ν> of the fluid based on a fluid (volume) flow rate through the channel and a flow-through area of the channel, and estimating the velocity νₑₛₜ as a local fluid velocity at a predetermined location in the channel based on a laminar flow profile of the fluid in the channel.

In embodiments, the scanner velocity is based on a fluid velocity near the wall of the channel, such as at a distance of the channel wall of a few percent to about one third of the diameter of the channel. Hence, in specific embodiments, a channel wall of the channel defines a channel width, d, and the estimated velocity νₑₛₜ is estimated at a position in the channel, wherein a ratio of a minimal distance, dₘᵢₙ, between said position and the channel wall is in the range of 0.05-0.3, especially in the range of 0.1-0.2.

### BRIEF DESCRIPTION OF THE DRAWINGS

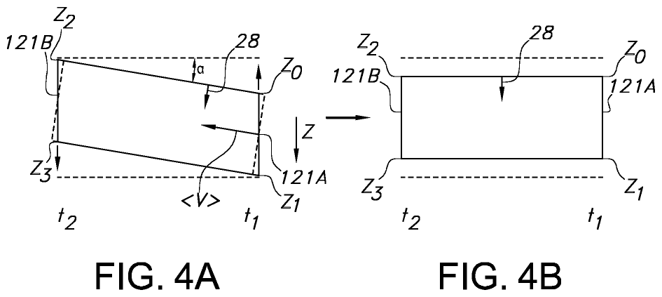

Embodiments of the invention will now be described, by way of example only, with reference to the accompanying schematic drawings in which corresponding reference symbols indicate corresponding parts, and in which FIGS. 1A-1D, 2, and 3 schematically depict general aspects of the invention; and FIG. 4 depicts some further aspects of the numerically alignment of the method. The schematic drawings are not necessarily to scale.

### DETAILED DESCRIPTION OF THE EMBODIMENTS

FIG. 1A schematically depicts a geometry for OCT flow measurements, depicted in 2D. The fluid 10 flows in a channel 25 comprising the sample space 20. The channel 25 is oriented at an angle α with respect to an x-y plane 201 perpendicular to the illumination direction in z. In general, a flow of the fluid 10 being laminar with transverse (that is in x and y direction) νₜ(z) and axial ν_{z}(z) components as a function of depth may be assumed. Given a total flow ν₀(z), the flow components may be expressed as νₜ=ν₀(z)cos(θ) and ν_{z}=ν₀(z)sin(θ). The angles α and θ may not be equal due to a beam refraction. The depicted OCT beam is a Gaussian beam characterized by the waist w₀ in focus, defined as a distance from a center of the beam 129 where the field amplitude is 1/e of its maximum value. Yet, in further embodiments the beam may also have another shape (as is known by the skilled person). The OCT beam 129 can be moved with the scanner velocity ν_{b}, i.e. in the x-y-plane 201 (perpendicular to the beam 129). Herein also the phrase “moving the scanner with a scanner velocity” and comparable phrases are used especially indicating that the beam 129 is moved with the scanner velocity (or beam velocity) ν_{b}. Based on this movement effectively the fluid 10 in the sample space 20 is scanned with scan speed νₛ. Because of this, it may be described herein that the projection of the scan speed νₛ in the transverse plane 201 is ν_{b}. Likewise it may be stated that the projection of the scanner speed ν_{b} onto the fluid flow ν₀ direction is the νₛ.

In FIGS. 1B-D this is further depicted in 3D. In FIG. 1B the orientation of the different velocity vectors with respect to the transverse plane or x-y plane 201 and the axial plane 210 are depicted in 3D, whereas FIG. 1C schematically depicts their projection in the axial plane 210, and FIG. 1D depicts the projection in the transverse plane 201. Here φₜ and φ_{z} are the angles between the scanning and flow vectors in the transverse and axial planes, respectively. The projection of the scan speed (or scan velocity) νₛ in the axial plane is given by νₛ′. The projection of the scan speed νₛ in the transverse plane is given by ν_{b}.

A commonly used method for measuring axial flow velocity is through phase-resolved Doppler OCT. Due to the Doppler effect, the frequency of light scattered from a particle undergoing axial motion is shifted. The Doppler shift in the scattered light leads to a phase change of the OCT signal, Δφ(z). From the phase change the axial depth-resolved velocity ν_{z}(z) may be determined using ν_{z}(z)=Δφ(z)/qΔt, where Δt is the sampling time, and q=2nk₀ the scattering wavenumber for the backscattering probe configuration, wherein n is the refractive index, n=c/ν with c being the speed of light in vacuum and ν the phase velocity of the light in the fluid. The total and axial flow velocities are related with the expression ν₀(z)=ν_{z}(z)/sin(θ). The maximum velocity that can be estimated using this expression is limited by the Nyquist sampling criterion. The maximum unambiguously measurable axial velocity is ν_{z,max}=π/qΔt for low transverse velocity. Especially at high transversal velocities, because of the changing intensity of the illuminating beam on the moving particles, the phase change does not increase linearly with the velocity and approaches a constant value making it impossible to extract the velocity information.

Basically, Doppler methods may only be used to determine axial flows. To determine both axial and transverse flows, correlation-based methods may be used. For a Gaussian illuminating beam and Gaussian-shape spectral envelope, the depth-dependent autocovariance of the OCT complex signal in a backscattering geometry may be given by the next formula:

$${g}_{1} ( z , τ ) = {A}_{1} ( z ) {e}^{{iqv}_{z} ( z ) τ} {e}^{- {Dq}^{2} τ} {e}^{- \frac{{{v}_{z} ( z )}^{2} {τ}^{2}}{2 {w}_{z}^{2}}} {e}^{- \frac{{{v}_{t} ( z )}^{2} {τ}^{2}}{{w}_{0}^{2}}} ,$$

wherein where D is the diffusion coefficient, w_{z} is the coherence function waist (1/e radius) in the sample, and τ is the correlation time lag. For the Gaussian spectrum, w_{z}=1/(σₖn\sqrt{2}), with σₖ being the source wavenumber spectrum standard deviation and n the sample refractive index. The parameter A₁(z) is the autocovariance amplitude containing the effect of a diminishing signal-to-noise in depth and takes values between 0 and 1. Note that the decorrelation only depends on the in-focus beam radius w₀ than the field decorrelation and can be expressed using the second-order autocovariance:

$${g}_{2} ( z , τ ) = \vert {g}_{1} ( z , τ ) \vert = {A}_{2} ( z ) {e}^{- 2 {Dq}^{2} τ} {e}^{- \frac{{{v}_{z} ( z )}^{2} {τ}^{2}}{{w}_{z}^{2}}} {e}^{- \frac{2 {{v}_{t} ( z )}^{2} {τ}^{2}}{{w}_{0}^{2}}} ,$$

wherein where A₂(z) is a depth-dependent amplitude factor. The above given formulae describe some examples that may be used in the method and are only given for further explaining the methods. Further examples are known to the skilled person. Below further reference is made to the second-order autocovariance g₂(z, τ).

When the autocovariance function is used for estimating the flow, the 1/e decay time of the autocorrelation must especially be equal or larger than the temporal sampling Δt. From this requirement, the maximum measurable transverse and axial flow speeds are ν_{t,max}=w₀/√2Δt, and ν_{z,max}=w_{z}/Δt. These maximum flow speeds are derived under the assumption of ideal sampling. However, when the measurements are performed while integrating over a specific detector time, defined T=Δt/C (with C, the multiplicative constant, being larger or equal to 1), the axial motion of a sample during the integration time may cause a significant SNR degradation that limits the axial velocity to ν_{z,max}=C/qΔt.

The maximum measurable flow speed ν_{t,max}=w₀/√2Δt, and ν_{z,max}=w_{z}/Δt. limit the maximum measurable transverse and axial velocity components from a correlation perspective: when the effective particle displacements become comparable to the transverse and axial resolutions, the acquired signals become completely decorrelated within a single acquisition time. Formula ν_{z,max}=πC/qΔt limits the axial velocity due to the fringe washout at the detector. For a spectrometer-based OCT systems, the detector integration time may be comparable to the sampling time, i.e. C≳1. Such systems may especially operate in the visible and infrared wavelength ranges with q>>1/w_{z}, therefore limiting the axial velocity by the fringe washout, i.e., through ν_{z,max}=πC/qΔt., rather than by the axial resolution, i.e., through ν_{z,max}−w_{z}/Δt.

To circumvent the limit imposed ν_{t,max}=w₀/√2Δt, the method of the invention comprises implementation of flow quantification using B-scan correlation analysis. When moving the OCT beam in any direction with constant vs, while acquiring the signal, νₜ(z) and ν_{z}(z) in the autocorrelation function should be replaced by effective transverse and axial velocities, respectively Δνᵣ(z) and Δν_{z}(z) given by:

$$Δ {{v}_{t} ( z )}^{2} = [ {( {v}_{0} ( z ) - {v}_{s} cos ( {φ}_{t} ) )}^{2} + {( {v}_{s} sin {φ}_{t} )}^{2} ] {cos}^{2} θ = [ {{v}_{0} ( z )}^{2} -- 2 {v}_{0} ( z ) {v}_{s} cos ( {φ}_{t} ) + {v}_{s}^{2} ] {cos}^{2} θ , and$$

$$Δ {{v}_{z} ( z )}^{2} = [ {( {v}_{0} ( z ) - {v}_{s} cos ( {φ}_{z} ) )}^{2} + {( {v}_{s} sin {φ}_{z} )}^{2} ] {sin}^{2} θ = [ {{v}_{0} ( z )}^{2} - 2 {v}_{0} ( z ) {v}_{s} cos ( {φ}_{z} ) + {v}_{s}^{2} ] {sin}^{2} θ ,$$

wherein φₜ and φ_{z} are the angles defining the scan direction, shown in FIGS. 1B-D. When the beam motion is sufficiently aligned with the flow velocity, so that cos(φₜ) and cos(φ_{z}) are about one, these equations may be simplified to:

$$Δ {v}_{t} ( z ) = ( {v}_{o} ( z ) - {v}_{s} ) cos θ = Δ {v}_{o} ( z ) cos θ , and$$

$$Δ {v}_{z} ( z ) = ( {v}_{o} ( z ) - {v}_{s} ) sin θ = Δ {v}_{o} ( z ) sin θ .$$

Hence, with an ideal scanning alignment, the ratio of the effective transverse and axial velocity components remains unchanged irrespective of the beam scanning speed. This simplification removes extra unknowns from the decorrelation rate and makes it possible to determine the velocity components in the identical way with or without scanning the beam. Therefore, a generalized autocovariance model of the OCT signal magnitude incorporating the beam motion can be written as

$${g}_{2} ( z , τ ) = {A}_{2} ( z ) {e}^{- 2 {Dq}^{2} τ} {e}^{- \frac{{( {v}_{0} ( z ) - {v}_{s} )}^{2} {sin}^{2} {θτ}^{2}}{{w}_{z}^{2}}} {e}^{- \frac{2 {( {v}_{0} ( z ) - {v}_{s} )}^{2} {cos}^{2} {θτ}^{2}}{{w}_{0}^{2}}}$$

This modified formula especially holds for systems wherein the optical path length z is close to, especially the same, for all physical depths in the B-scan. For this modified formula the axial velocity limit is unchanged and limited by the fringe washout via ν_{z,max}=πC/qΔt. However, the transverse velocity limit is modified and is now limited by the relative velocity |νₜ−νₛ cos(θ)| rather than the absolute velocity νₜ. This implies that for flows uniform along the length of the B-scan the maximum measurable flow is limited by the absolute difference between flow and scanning speeds. The application of B-scanning in correlation analysis can give a significant improvement because for a typical OCT flow geometry the transverse flow is much higher than the axial flow and the limitation caused by the transverse flow is more restrictive than that for axial flow. For a flow profile νₜ(z) the most optimum scan speed may in embodiments be selected such that the decorrelation rate is at its maximum for the highest and lowest flows, i.e., the scan speed, is mid-range in the flow velocity with νₛ cos(θ)=(max(νₜ(z))+min(νₜ(z)))/2. This scanning speed may cause maximum and equal decorrelation rates for the maximum and minimum flow speeds.

Hence, by moving the scanner, the maximum transverse velocity may be limited at

$${max}_{B - scan} ( {v}_{t} ( z ) ) = \frac{\sqrt{2} {w}_{0}}{Δ t} + \frac{min ( {v}_{t} ( z ) )}{2} ,$$

for flow profiles with min (νₜ(z))=0. Hence, the B-scan flow limit is a factor of 2 larger than the M-scan correlation flow limit. This equation is based on the assumption that there is only a small angle φ between scanning and flow vectors. Experimentally, it appeared that with angles up to 10° the method using the small angle approximation provided good results. To obtain the actual flow speeds, the scan speeds need to be added to the effective velocities after acquisition. Therefore, for flows with a non-uniform transverse component, assuming that the beam can be moved at sufficiently high velocities, the maximum flow that can be determined with B-scanning is at least twice the flow that can be determined without. Same relations can be applied to the axial flow if a numerical alignment is applied.

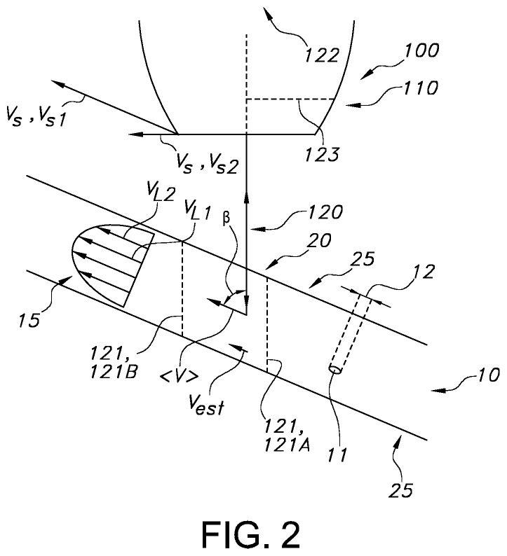

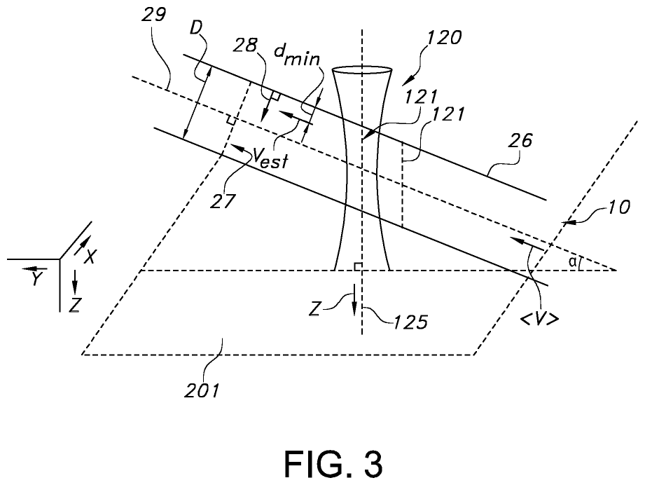

In FIGS. 2-3 some further aspects of the method are depicted. The method is used for determining a characteristic of a flowing fluid 10 in a sample space 20 by optical coherence tomography (OCT). In the fluid 10 only a single particle 11 is depicted for clarity reasons. The method may especially be used to determining one or more characteristics of a diffusion coefficient D of particles 11 in the fluid 10, a size 12 of the particles 11 in the fluid 10, a shape of the particles 11 in the fluid 10, a particle size 12 distribution PSD of particles 11 in the fluid 10, a local velocity, νₗ, of the fluid 10, a velocity profile of the fluid 10 in the sample space 20, and a mean velocity, <ν>, of the fluid 10 in the sample space 20.

The method may comprise different steps, such as estimating a velocity νₑₛₜ of the fluid 10 in the sample space 20; controlling an optical scanner 110 to radiate a beam 129 of measurement light 120 along an optical path 121 to the fluid 10 in the sample space 20 and to sense a signal 122 (of interference) of (measurement) light 120 scattered back along the optical path 121 mixed with reference reflected measurement light 123. Because, sensing a signal 122 of interference of reference light with backscattered light, is more or less standard for OCT measurement, this part is only very schematically depicted in the figure by mixing (or “combining”) the reference light 123 with backscattered light 120, that successively propagate to give a signal of interference 122 on a sensor or detector of the scanner 110. The last being very schematically indicated by the arrow pointing to a location where the lights 123, 120 interfere on the sensor/detector. Further, the optical scanner 110 is moved with a scanner velocity, ν_{b}. This scanner velocity ν_{b} refers to a physical movement of the scanner 100 and may herein also be indicated as the beam velocity ν_{b} or the velocity of the beam 129. This scanner velocity ν_{b}, and there with the scan velocity vs, is especially (set based on) a function of the velocity, νₑₛₜ, of the fluid 10. The method further comprises processing the signal 122 into a corresponding complex-valued optical path 121 length z resolved OCT signal a(t, z), herein also (simply) indicated as OCT signal. The OCT signal may especially represent the fluid 10 in the sample space 20. In embodiments processing the signal 122 comprises deriving the complex-valued optical path (121) length, z, resolved OCT signal, a(t, z), from a time-resolved OCT wavelength spectrum of interference.

In embodiments, the scanner 110 is moved in a scanner direction (a direction of the scanner velocity ν_{b}) being aligned with a velocity component of the velocity, νₑₛₜ, of the fluid 10 (in a plane) perpendicular to the optical axis 125 of the beam 129 of measurement light 120. In further embodiments, the scanner 110 is moved in alignment with an overall flow direction of the fluid 10 in the sample space 20. The directions of the scanner velocity ν_{b} may thus differ between embodiments. In the FIG. 2, this is schematically indicated by two scanner velocities ν_{b1} and ν_{b2}. The movement of the scanner 10 relative to the sample space 20 may be selected based on an estimated velocity νₑₛₜ at a specific location in the sample space 20. The local velocity νₗ may differ significantly depending on the location in the samples space 20. For instance, in the depicted embodiment in FIG. 2, a laminar flow profile 15 is depicted. Here, the velocity ν_{l,1} or speed at a first location is about 25% higher than the value of the velocity ν_{l,2} at the second location. The scanner velocity ν_{b} may especially be selected to be the mean value of the lowest (estimated) local velocity νₗ and the highest (estimated) local velocity νₗ in the scanning space 20. It is noted that in FIG. 2 the local velocity (speed) is indicated with νₗ, whereas in FIGS. 1 ν₀ refers to the local velocity (speed).

The method may further comprise determining the characteristic of the fluid 10 based on the OCT signal a(t, z).

Above, many different ways are described to determine the characteristics. Determining the characteristic may especially (repeatedly) determining the autocorrelation function of the OCT signal a(t, z) in the time domain and/or determining the frequency power spectrum of the OCT signal a(t, z) in the spectral domain (for both ways), especially for voxels in the sample space 20 that are irradiated with the measurement light 120 (while moving the optical scanner 110).

In further embodiments, e.g., the characteristic of the fluid 10 is determined based on a first-order autocovariance of the complex-valued OCT signal.

The method may comprise Fourier domain low coherence tomography FD-LCT.

The method may further comprise calculating the size 12 of one or more particles 11, especially more particles and/or a particle size distribution (PSD) from their diffusion coefficients, wherein the diffusion coefficients are determined from the autocorrelation function of the OCT signal and/or from the frequency power spectrum of the OCT signal 122.

FIG. 2 further depicts an angle β between the optical path 121 and (the direction of) the mean velocity <ν> of the fluid 10. Essential the angle β relates to the angle α, e.g., given in FIG. 1. The sum of these angle α, β may be equal to 180°. Furthermore, some different optical paths 121 based on the movement of the scanner 110 are depicted with reference 121A and 121B. Especially a plurality of optical paths 121 may define the sample space 20.

FIG. 3, further schematically depicts some further aspects of the method. In the figure, the mean velocity <ν> is depicted, which can be defined for the depicted channel 25 as a ratio of the total fluid 10 flow (rate) through the channel 25 to the flow-through area 27 (herein also indicated as cross section 27, or cross-sectional area 27). This is especially the inner cross section 27 defined by the channel wall 26 and perpendicular to the channel axis 29. It is further noted that in FIG. 3 further the depth direction 29 and the z-direction are depicted; showing that they are not aligned.

FIG. 4, further schematically depicts the numerical aligning when the scanner direction and an overall flow direction as indicated by the arrow of <ν> of the of the fluid 10 define an oblique angle α the method may comprise numerically aligning. In the figure this is very schematically depicted. Basically, measured (processed) signals at a respective z value may be translated to a new z value such that, such that for a first range of optical path lengths z₀ to z₁ indicative for a presence of fluid 10 at a first time t₁ and a second range of optical path lengths z₂ to z₃ indicative for the presence of fluid 10 at a second time t₂ in the sample space, z₂ and z₀ are substantially equal (have the same value) and z₀ and z₃ are substantially equal

Numerically aligning is especially performed prior to determining the autocorrelation function of the OCT signal and/or prior to determining the frequency power spectrum of the OCT signal.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein, amongst others, be described during operation. As will be clear to the person skilled in the art, the invention is not limited to methods of operation, or devices, apparatus, or systems in operation.

The term “further embodiment” and similar terms may refer to an embodiment comprising the features of the previously discussed embodiment but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to an advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method, respectively.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A method for determining a characteristic of a flowing fluid in a sample space by Fourier domain optical coherence tomography (FD-OCT), the fluid comprising particles, wherein the method comprises:
estimating a velocity of the fluid in the sample space;
controlling an optical scanner to radiate a beam of light along an optical path to the fluid in the sample space and to sense a signal of interference of (i) measurement light-scattered back along the optical path mixed with (ii) reference reflected light, while moving the optical scanner, wherein the beam of light is moved with a scanner velocity being aligned with a velocity component of the velocity of the fluid perpendicular to the optical axis of the beam of light, wherein a ratio of a magnitude of the scanner velocity and a magnitude of the velocity of the fluid is in the range of 0.1-10;
processing the signal into a corresponding complex-valued optical path length, z, resolved OCT signal, a(t, z), wherein the OCT signal a(t, z) represents the fluid in the sample space, and
determining the characteristic of the fluid based on the OCT signal a(t, z), wherein the characteristic of the fluid comprises one or more of a size of the particles in the fluid, a shape of the particles in the fluid, a diffusion coefficient of the particles in the fluid, a particle size distribution (PSD) of particles in the fluid, a local velocity, νₗ, of the fluid, a velocity profile of the fluid in the sample space, and an mean velocity, <ν>, of the fluid in the sample space.

2. The method according to claim 1, wherein processing the signal comprises deriving the complex-valued optical path length, z, resolved OCT signal, a(t, z), from a time-resolved OCT wavelength spectrum of interference, and, wherein determining the characteristic of the fluid comprises determining at least one of (i) an autocorrelation function of the OCT signal, a(t, z) in a time domain and (ii) a frequency power spectrum of the OCT signal a(t, z) in the spectral domain, wherein the autocorrelation function of the OCT signal a(t, z) in the time domain comprises a z-resolved temporal autocorrelation function, G(τ, z), of a(t, z), in which t represents a lag time, and wherein the frequency power spectrum of the OCT signal a(t, z) in the spectral domain comprises a z-resolved frequency power spectrum, Ĝ(ω, z), of a(t, z), in which ω represents an angular frequency.

3. The method according to claim 2, wherein determining the characteristic of the fluid comprises one or more of repeatedly determining the autocorrelation function of the OCT signal a(t, z) in the time domain and/or the frequency power spectrum of the OCT signal a(t, z) in the spectral domain for voxels in the sample space that are irradiated with the measurement light, while moving the optical scanner.

4. The method according to claim 2, wherein determining the characteristic of the fluid based on the autocorrelation function of the OCT signal a(t, z) comprises one or more of:
determining, from G(τ, z), z- and τ-dependent decorrelation factors, g_{F}(τ, z), related to a flow of the fluid;
determining, from G(τ, z), z- and τ-dependent autocorrelations, g_{B}(τ, z), representative of Brownian motion of the particles;
determining, from G(τ, z), a characteristic optical path length, Zₛₛ, representative of a photon mean free path in the flowing fluid, for which g_{B}(τ, z) for z<Zₛₛ in the flowing fluid are independent of z within a measurement noise; and
determining, based on g_{B}(τ, z) for z<Zₛₛ in the flowing fluid, an averaged autocorrelation function, <g_{B}(τ)>, representative of single scattered measurement light, and performing a photon correlation spectroscopy (PCS) analysis using <g_{B}(τ)> to extract information related to the characteristic of the fluid; and
wherein determining the characteristic of the fluid based on the frequency power spectrum of the OCT signal a(t, z) comprises one or more of:
determining, from Ĝ(ω, z), z-resolved power spectra, ĝ_{F}(ω, z) related to the flow of the fluid;
determining, from Ĝ(ω, z), z-resolved power spectra ĝ_{B}(ω, z) representative of Brownian motion of the particles;
determining, from Ĝ(ω, z), a characteristic optical path length, Zₛₛ, representative of the photon mean free path in the flowing fluid, for which ĝ_{B}(ω, z) for z<Zₛₛ in the fluid are independent of z within the measurement noise; and
determining, based on ĝ_{B}(ω, z), for z<Zₛₛ in the flowing fluid, an averaged power spectrum, <ĝ_{B}(ω)>, representative of single scattered light, and deriving, from <ĝ_{B}(ω)>, information related to characteristic of the fluid.

5. The method according to claim 2, comprising determining a diffusion coefficient of the particles from the autocorrelation function of the OCT signal, a(t, z) and/or the frequency power spectrum of the OCT signal a(t, z) and calculating the size of the particle from the diffusion coefficient.

6. The method according to claim 5, wherein the method further comprises calculating the particle size distribution of a plurality of particles from sizes calculated for the respective particles.

7. The method according to claim 1, wherein the characteristic of the fluid is determined based on a first-order autocovariance of the OCT signal, a(t, z).

8. The method according to claim 1, wherein the scanner direction and an overall flow direction of the of the fluid define an oblique angle, α, wherein the method further comprises numerically aligning comprising translating OCT signal a(t, z) values along their respective optical paths relative to each other, such that for a first range of optical path lengths z₀ to z₁ indicative for a presence of fluid at a first time t₁ in the sample space, and a second range of optical path lengths z₂ to z₃ indicative for the presence of fluid at a second time t₂ in the sample space, z₂ and z₀ are substantially equal and z₀ and z₃ are substantially equal, wherein numerically aligning is performed prior to determining the characteristic of the fluid.

9. The method according to claim 8, wherein the method comprises:
processing the signal of interference into the corresponding complex-valued optical path length, z, resolved OCT signal, a(t, z) and successively spatially shifting the transformed signal of interference, or
applying a phase multiplication of the signal of interference in a frequency domain and successively Fourier transforming the phase multiplicated signal of interference to provide the complex-valued optical path length, z, resolved OCT signal, a(t, z).

10. The method according to claim 9, further comprising normalizing the signal of interference before numerically aligning, wherein the OCT signal a(t, z) is adjusted for a confocal point spread function, h(z), or wherein the OCT signal a(t, z) is normalized based on an average optical path, z, resolved amplitude signal.

11. The method according to claim 1, wherein the fluid is flown through a channel comprising the sample space, wherein estimating the velocity νₑₛₜ of the fluid in the sample space comprises:
determining the mean velocity, <ν>, of the fluid based on a fluid volume flow rate through the channel and a flow-through area of the channel, and
estimating the velocity, νₑₛₜ, as a local fluid velocity at a predetermined location in the channel based on a laminar flow profile of the fluid in the channel.

12. The method according to claim 11, wherein a channel wall of the channel defines a channel width (d), and wherein the estimated velocity, νₑₛₜ, is estimated at a position in the channel, wherein a ratio of a minimal distance (dₘᵢₙ) between said position and the channel wall is in the range of 0.1-0.2.

13. The method according to claim 1, wherein a ratio of a magnitude of the scanner velocity, ν_{b}, and a magnitude of the velocity, νₑₛₜ, of the fluid is in the range of 0.1-1.
